(19) United States
(12) Patent Application Publication
(10) Pub. No.: US 2026/0064080 A1
(43) Pub. Date: Mar. 5, 2026

(54) TIMEPIECE WITH RIGID CASING AND CASING METHOD

(71) Applicant: Certina S.A., Le Locle (CH)

(72) Inventors: Yoann MOSTEIRO VAZQUEZ, Montmagny (CH); Yann AESCHBACHER, Moutier (CH); Simon GARCIN, Salavaux (CH); Joslain BOSSY, Yverdon-les Bains (CH); Philipp TSCHUMI, Niederwil (CH); Steeve GERBER, La Neuveville (CH); Anthony SIPP, Domdidier (CH)

(73) Assignee: Certina S.A., Le Locle (CH)

(21) Appl. No.: 19/266,645

(22) Filed: Jul. 11, 2025

(30) Foreign Application Priority Data
Sep. 4, 2024 (EP) 24198458.2

(51) Int. Cl. G04B 37/05

(52) U.S. Cl. CPC G04B 37/05

(57) ABSTRACT

A timepiece (100) including a middle (10), a detachable back (12) mounted on the middle (10), a movement (20) and casing elements (30) for rigidly holding the movement (20) in an inner volume (15) of the middle (10), having a first casing circle (35) pressing against a shoulder (16) formed in the middle (10); a second casing circle (34), the movement (20) being rigidly held between the first casing circle (35) and the second casing element (34) via a peripheral rib (21) of the horology movement (20), the first casing circle (35) and the second casing circle (34) being superimposed with no direct contact with each other; a clamping element (33), separate from the detachable back (12), in direct contact with the second casing circle (34).

### CROSS REFERENCE TO RELATED APPLICATIONS

This application claims priority to European Patent Application No. 24198458.2, filed on Sep. 4, 2024, the entire contents of which are incorporated herein by reference.

### TECHNICAL FIELD OF THE INVENTION

The invention relates to a timepiece with a rigid casing for a horology movement and to a method for casing a horology movement in a middle of a timepiece.

### TECHNOLOGICAL BACKGROUND

Casing a horology movement, which involves fastening the movement in a middle, is generally done using fastening clamps which are inserted into grooves provided on the inner circumference of the middle, the entire assembly being fastened by clamp screws. However, the use of this solution is relatively complex due to the large number of parts and the various handling operations required to position the clamps and screws, all of which have a major impact on the productivity of such a casing solution.

There are also other known casing solutions using an intermediate part, such as a casing circle or an enlarging circle, positioned around the horology movement so as to hold it in position while a back is screwed onto the middle. Although this solution allows the movement to be fastened quickly, it requires a gap to be left between the horology movement and the middle to hold the casing circle, which limits the potential dimensions of the movement relative to the dimensions of the middle.

Moreover, various studies have shown that these casing solutions not only transmit shocks to the middle to the movement, but can also amplify them. Consequently, casing systems need to be improved to minimise shocks to the horology movement, in particular to avoid damage, marred components or loss of connection of certain components.

A conventional solution is to insert a shock absorber, such as an elastomer ring, between the middle and the movement, but this requires a large available volume.

Another solution proposed in document EP 1970779 consists of casing the movement using two casing circles which are superimposed and in contact with each other, between which the horology movement is held. These two circles are themselves compressed between part of the middle of the timepiece and the back of the timepiece by an annular joint. One of the circles has a countersink through which the arbor of a winding mechanism arbor can be inserted. The annular joint is provided to hold the lower casing circle, and accordingly the movement, axially and radially in place when the back is closed. However this type of casing creates play in the movement positioned between the two casing circles. Moreover, this play can vary depending on the manufacturing tolerances for the casing circles and for the rib of the horology movement, even though an annular joint has been provided to ensure that the circles are sufficiently compressed.

Consequently, with such a casing solution, the shock resistance of horology movements can vary because in certain situations, the horology movement can move between the two casing circles, which in turn amplifies the shock to the middle in the horology movement.

There is therefore a need to improve timepieces with rigid casings to address at least one of the problems outlined above.

There is also a need to improve a method for rigidly casing a horology movement in a timepiece middle, and to provide such a method free from the limitations outlined above.

### SUMMARY OF THE INVENTION

The invention primarily aims to provide a timepiece with a rigid casing for improved shock resistance of the horology movement encased in the middle.

To this end, the invention aims to provide a timepiece comprising a middle, a detachable back mounted on the middle, a movement and casing elements for rigidly holding the movement in an inner volume of the middle.

According to the invention, the casing elements comprise:
a first casing circle pressing against a shoulder formed in the middle;
a second casing circle, said movement being rigidly held between the first casing circle and the second casing element via a peripheral rib of the horology movement, the first casing circle and the second casing circle being superimposed with no direct contact with each other;
a clamping element, separate from the detachable back, in direct contact with the second casing circle, the clamping element being designed to compress the movement axially between the first casing circle and the second casing circle and to compress the first casing circle axially against the shoulder of the middle.

The invention primarily aims to provide a rigid casing for the horology movement that makes it easier to encase the horology movement in the middle and minimises the strain and distortions to which the horology movement is exposed in the event of an accidental shock to the timepiece.

The casing provided by the invention increases the rigidity of the casing and ensures that the horology movement is held in place with no play in the movement, irrespective of the manufacturing tolerances of the casing circles and the middle.

The casing provided by the invention also makes it easier to mount the horology movement in the middle.

In addition to the characteristics mentioned in the previous paragraph, the timepiece according to the invention can have one or more complementary characteristics from among the following, taken individually or in any technically possible combination:
the clamping element is a clamp ring screwed into the middle;
the clamping element comprises, on an outer circumference, a thread cooperating with a tapping formed in the middle, the tapping in the middle for clamping the clamp ring being configured to receive the detachable back by screwing;
the timepiece comprises the following axial superposition: middle, first casing circle, second casing circle, clamping element and detachable back, the first casing circle and the second casing circle not being in contact with each other;
the first casing circle comprises a shoulder cooperating with the shoulder of the middle;
the first casing circle and the second casing circle are made of a rigid material with a Young's modulus greater than 50 GPa;
the first casing circle covers the horology movement and holds a dial on an upper face of the first casing circle;
the dial is attached to the upper face of the first casing circle, preferably by gluing;
first casing circle covers the horology movement and in that an upper face of the first casing circle forms a dial.

The invention also relates to a rigid casing method for fastening a horology movement in a timepiece middle according to the invention. The method comprises the following successive steps:
a step in which the first casing circle and the horology movement are pre-assembled, such that an upper portion of the peripheral rib of the horology movement presses against an annular shoulder of the first casing circle;
a step in which the sub-assembly formed in the preceding step is inserted into the middle such that the first casing circle presses against a shoulder of the middle, the upper portion of the peripheral rib of the horology movement pressing against an annular shoulder of the first casing circle;
a step in which the second casing circle is inserted into the middle, the second casing circle pressing against a lower portion of the peripheral rib of the horology movement, with no direct contact with the first casing circle;
a step in which the clamping element is clamped in the middle such that the stack formed by the second casing circle, the horology movement and the first casing circle is compressed against the shoulder of the middle.

Preferentially, the clamping step is carried out by screwing the clamping element into the middle.

The casing method can be manual, meaning that it can be carried out by a natural person, or it can be automated.

### BRIEF DESCRIPTION OF THE FIGURES

The purposes, advantages and characteristics of the present invention will become apparent from the detailed description below in reference to the following figures:

FIG. 1 is an exploded perspective view of a timepiece according to the invention comprising a middle, a horology movement mounted in the middle and casing elements for rigidly fastening the horology movement in the middle;

FIG. 2 is a cross-sectional view of the timepiece according to the invention;

FIG. 3 is a view of the underside of the timepiece illustrated in FIG. 1; FIG. 3 illustrating in particular the casing elements in position in the middle;

FIG. 4 is a perspective view of the casing elements according to the invention;

FIG. 5 is a flow chart illustrating the main steps in a method for casing a horology movement according to the invention.

In all of the figures, common elements have the same reference numbers unless otherwise specified.

### DETAILED DESCRIPTION OF THE INVENTION

In the present application, the axial direction is a direction extending perpendicularly to a plane formed by the dial or the plate of the horology movement, referenced here as P1. On the other hand, a radial direction is parallel to the plane P1 formed by the dial or the plate.

The terms “inner” and “outer” are to be considered with reference to the centre of the timepiece, so that an inner face is closer to the centre than an outer face which is opposite the centre of the timepiece.

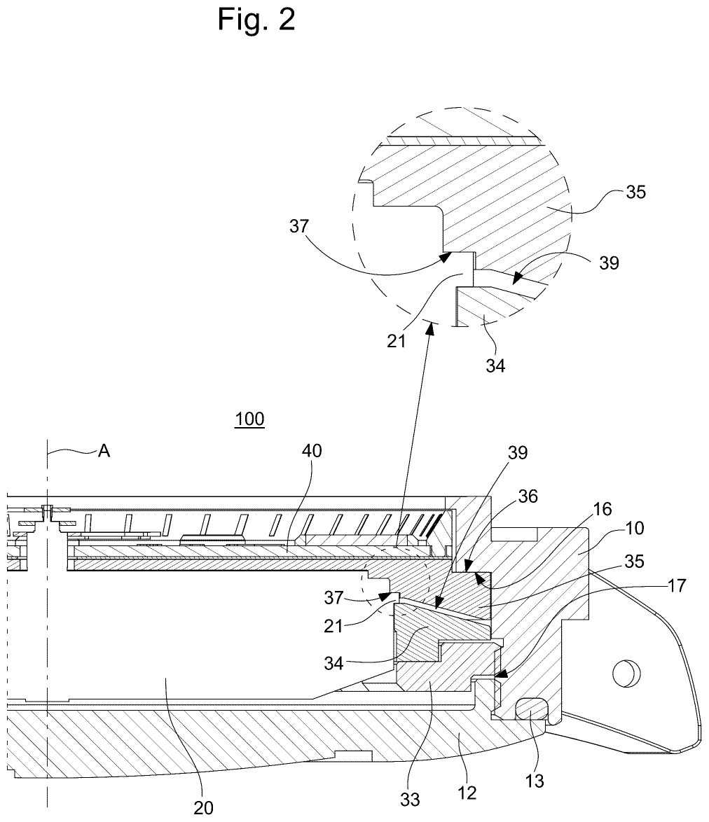

The terms “upper” and “lower” are to be considered in reference to a watch placed on its back as shown in FIG. 2.

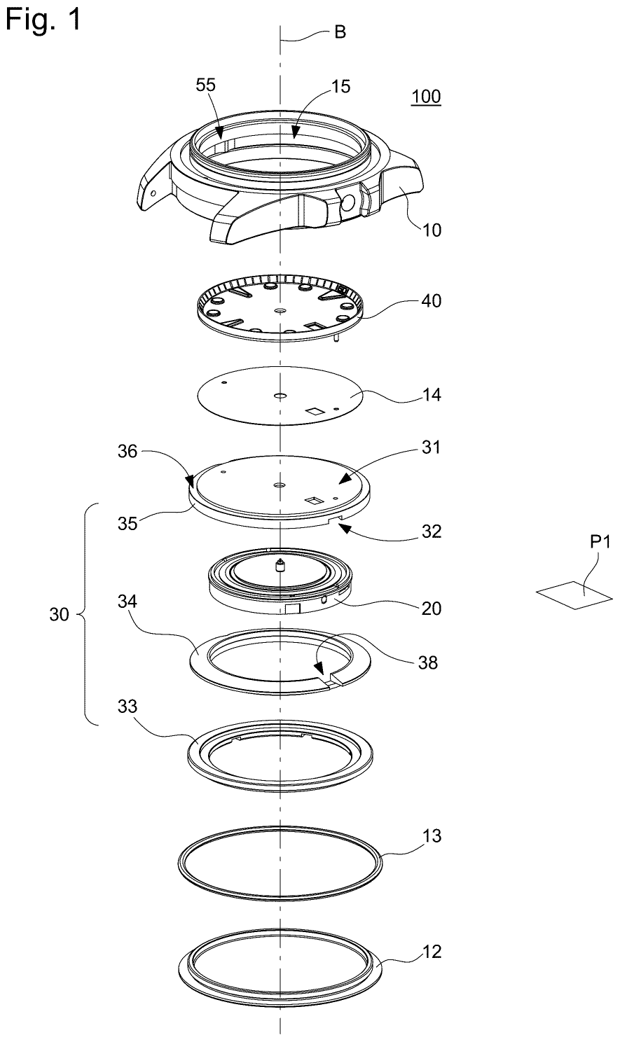

FIG. 1 is an exploded perspective view of a timepiece 100 according to the invention, with a central axis B, comprising a middle 10 configured to be closed on either side by a detachable back 12 and a glass (not shown).

For example, the middle 10 is made of metal, ceramic, polymer or a combination of different materials.

The timepiece 100 comprises a horology movement 20 housed in an inner volume 15 delimited by the middle 10 and held in position in the middle 10 by casing elements 30.

The horology movement 20 can be mechanical, electromechanical or electronic.

The horology movement 20 has a central axis A perpendicular to a general plane P1. The central axis A of the horology movement 20 is parallel or corresponds to the rotational axis of the hands of the movement.

The central axis A of the horology movement 20 is parallel or corresponds to the central axis B of the middle 110.

A dial 40 is positioned above the horology movement 20.

As illustrated in FIG. 2, which is a cross-sectional view of the timepiece according to the invention, and in FIG. 4, which illustrates a perspective view of the casing elements 30, the casing elements 30 according to the invention comprise a first casing circle 35, which forms the upper element of the casing elements 30, pressing against a shoulder 16 of the middle 10. The shoulder 16 is an annular shoulder parallel to the plane P1 of the horology movement 20.

The first casing circle 35 comprises a peripheral shoulder 36 designed to cooperate by pressing against the shoulder 16 of the middle 10.

The first casing circle 35 can be made of any rigid, non-elastomer material, for example metal or a synthetic material. Preferentially, the first casing circle 35 is made of a rigid, non-elastomer material with a Young's modulus greater than 50 GPa.

The first casing circle 35 is not split around its circumference, but has a partial opening 32 through which an arbor of a winding mechanism (not shown) can be inserted.

The periphery of the horology movement 20 comprises, on its outer circumference, a peripheral rib 21 pressing, at the level of an upper surface of this peripheral rib 21, against an annular shoulder 37 formed on a radially inner portion of the first casing circle 35.

The peripheral rib 21 can extend continuously all around the horology movement 20 and be annular in form or be made up of discontinuous segments of equal or unequal lengths around the horology movement 20.

The axial position of the horology movement 20 in the middle 10 is determined by the dimensions of the first casing circle 35 and in particular by the axial position of the annular shoulder 37, on which the horology movement 20 presses, relative to the shoulder 36 of the first casing circle 35 pressing against the shoulder 16 of the middle 10.

The casing elements 30 according to the invention comprise a second casing circle 34 superimposed under the first casing circle 35. The second casing circle 34 presses against the lower surface of the peripheral rib 21 and forces the peripheral rib 21 of the horology movement 20 against the annular shoulder 37 of the first casing circle 35.

The upper face of the second casing circle 34 thus defines together with the annular shoulder 37 of the first casing circle 35, a bed in which the annular peripheral rib 21 of the horology movement 20 is clamped.

The horology movement 20 is therefore constrained between the first casing circle 35 and the second casing circle 34 when the timepiece 100 is assembled. According to the invention, the first casing circle 35 and the second casing circle 34 are not in direct contact with each other, such that a gap 39 is provided between the two casing circles 34, 35 when the timepiece 100 is assembled.

Like the first casing circle 35, the second casing circle 34 can be made of any rigid, non-elastomer material, for example metal or a synthetic material. Preferentially, the second casing circle 34 is made of a rigid, non-elastomer material with a Young's modulus greater than 50 GPa.

The two casing circles 34, 35 can be made of identical or different materials.

The second casing circle 34 is not split around its circumference, but has a partial opening 38 through which an arbor of a winding mechanism can be inserted.

The casing elements 30 according to the invention also comprise a clamping element 33, separate from the detachable back 12, in direct contact with the second casing circle 34. The clamping element 33 forms the lower of the casing elements 30 and is shaped to axially compress the horology movement 20, via the annular peripheral rib 21 between the first casing circle 35 and the second casing circle 34 and to axially compress the first casing circle 35 against the shoulder 16 of the middle 10.

The clamping element 33 is, for example, a clamp ring comprising, on its outer circumference, a thread configured to cooperate with a tapping 17 provided on an axial inner face of the middle 10. The clamp ring 33 is screwed into the middle 10 until the assembly formed by the casing circles 34, 35 and the horology movement 20 is clamped against the shoulder 16 of the middle 10.

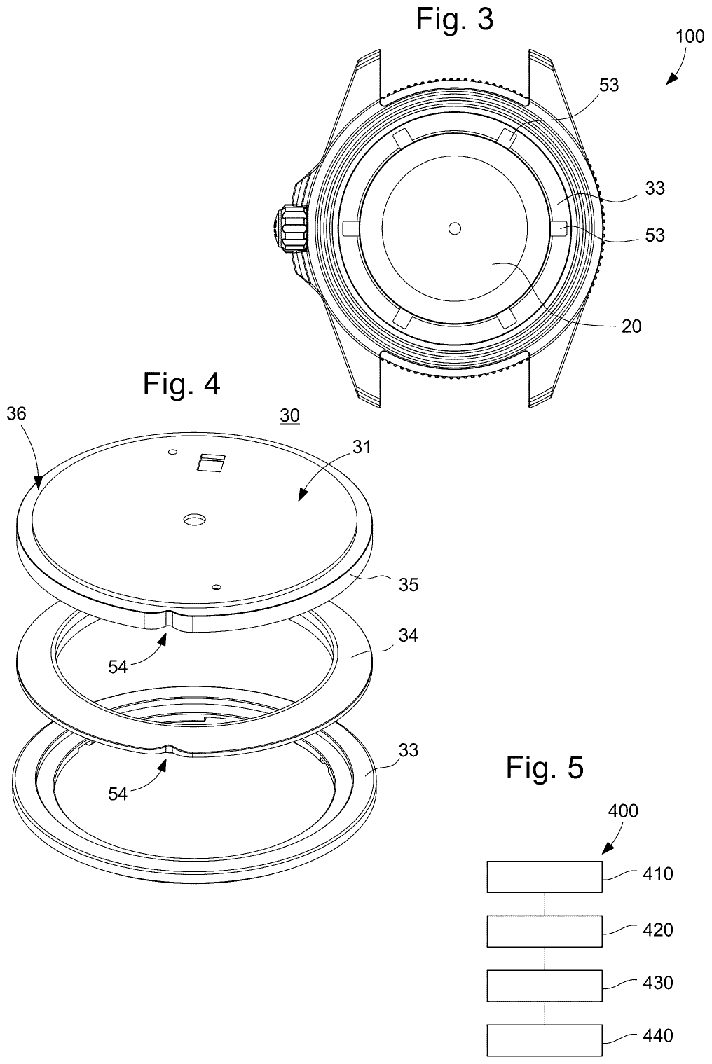

As illustrated in FIG. 3, the clamp ring 33 comprises impressions 53 on its lower face, enabling a tool to be inserted to make it easier to screw in and clamp the clamp ring 33 in the middle 10.

The casing elements 30 according to the invention enable the horology movement 20 to be axially secured in the middle 10 by compressing it between the two casing circles 34, 35, but also radially by the frictional forces generated at the annular shoulder 37 of the first casing circle 35 and by the upper surface of the second casing circle 34.

Advantageously, the annular shoulder 37 of the first casing circle 35 comprises a lateral wall forming a radial stop for the peripheral rib 21 of the horology movement 20, so as to limit to the extent possible the radial movements of the horology movement 20 before clamping while ensuring mounting clearance for the horology movement 20 inside the first casing circle 35.

The two casing circles 34, 35 comprise a male or female positioning organ cooperating with a complementary female or male positioning organ so as to form a keying system. This keying system forms an anti-rotation device which keeps the casing circles 34, 35 from rotating. Such a system also helps to avoid applying torque to the horology movement 20 when clamping the clamp ring 33.

As illustrated in FIGS. 1 and 4, the two casing circles 34, 35 comprise a female positioning organ 54 cooperating with a male positioning organ 55 (visible in FIG. 1) formed on the radially inner wall of the casing 10.

The keying system also enables the two casing circles 34, 35 to be lined up such that the openings 32, 38 are aligned to form a through hole for the arbor of the winding mechanism of the timepiece 100.

Preferentially, the tapping 17 in the middle 10 can also be used to screw the detachable back 12 thereon. An annular joint 13, such as an O-ring, is compressed between the detachable back 12 and the middle 10 to ensure that the timepiece 100 is water-resistant. The annular joint 13 is housed in a groove machined into the middle 10. For example, the annular joint 13 has a circular cross-section.

Preferentially, the first casing circle 35 covers the horology movement and carries the dial 40.

The dial 40 is attached to the first casing circle 35 and is fitted flush with the upper face 31 of the first casing circle 35.

For example, the dial 40 is glued to the upper face 31 of the first casing circle 35 using an adhesive element 14.

For example, the dial 40 is welded, brazed or screwed to the upper face 31 of the first casing circle 35.

The dial 40 can also be formed directly on the upper face 31 of the first casing circle 35.

### Method for Casing a Horology Movement in a Timepiece According to the Invention

The invention also relates to a method 400 for casing a horology movement 20 in a middle 10. To carry out the casing of the horology movement 20, a first step 410 consists of pre-assembling the horology movement 20 with the first casing circle 35 so as to form a sub-assembly. In this sub-assembly, an upper portion of the peripheral rib 21 of the horology movement 20 presses radially against the inner annular shoulder 37 of the first casing circle 35. Once the two elements have been pre-assembled, the hands, for example, are driven onto the horology movement. As previously described, in this first step 410, the first casing circle 35 is pre-retained with the horology movement 20 to form the sub-assembly; that is, they are positioned together but the first casing circle is not attached to the horology movement 20.

Optionally, a preliminary step to the first casing step 410 consists of attaching the dial 40 to the first casing circle 35 if the latter forms a resting surface for the dial 40.

A second step 420 consists of inserting the sub-assembly formed by the first casing circle 35 and the horology movement 20, and optionally the dial 40, into the middle 10, from the back side. The first casing circle 35 then presses against the bearing surface 16 of the middle 10 and the horology movement 20 radially presses against the inner annular shoulder 37 of the first casing circle 35.

A third step 430 consists of inserting the second casing circle 34, into the middle 10, through the back side, such that the second casing circle 34 presses against the lower portion of the peripheral rib 21 of the horology movement 20. More specifically, a portion of the upper face of the second casing circle 35 presses against the lower portion of the peripheral rib 21 of the horology movement 20.

A fourth step 440 consists of clamping the assembly by mounting the clamping element 33, separate from the detachable back 12, in the middle so as to compress the stack formed by the second casing circle 34, the horology movement 20 and the first casing circle 35 against the shoulder 16 of the middle 10, and to lock the horology movement 20 axially and radially in the middle 10.

Preferentially, the fourth clamping step 440 is carried out by screwing the clamping element 33 into the middle 10 by means of a thread cooperating with a tapping. For example, the clamping element 33 carries the thread and the middle 10 carries the thread 17; however, the opposite is also possible without departing from the context of the invention.

The casing elements 30 according to the invention enable the horology movement 20 to be held in position in the middle 10 with no need to mount the detachable back. The detachable back was not necessary for the axial and radial retention of the horology movement 20.

In general, the invention has been described with operations carried out by an operator. However, the invention can also be used with automated systems or robots, so the casing method for a horology movement according to the invention can be a manual method or an automated method.

1. A timepiece comprising a middle, a detachable back mounted on the middle, a movement and casing elements for rigidly holding the movement in an inner volume of the middle, wherein the casing elements comprise:
a first casing circle pressing against a shoulder formed in the middle;
a second casing circle, said movement being rigidly held between the first casing circle and the second casing element via a peripheral rib of the horology movement, the first casing circle and the second casing circle being superimposed with no direct contact with each other;
a clamping element, separate from the detachable back, in direct contact with the second casing circle, the clamping element being designed to compress the movement axially between the first casing circle and the second casing circle and to compress the first casing circle axially against the shoulder of the middle.

2. The timepiece according to claim 1, wherein the clamping element is a clamp ring screwed into the middle.

3. The timepiece according to claim 1, wherein the clamping element comprises, on an outer circumference, a threading cooperating with a tapping formed in the middle, the tapping in the middle for clamping the clamp ring being configured to receive the detachable back by screwing.

4. The timepiece according to claim 1, wherein said timepiece comprises the following axial superposition: middle, first casing circle, second casing circle, clamping element and detachable back.

5. The timepiece according to claim 1, wherein the first casing circle comprises a shoulder cooperating with the shoulder of the middle.

6. The timepiece according to claim 1, wherein the first casing circle and the second casing circle are made of a rigid material with a Young's modulus greater than 50 GPa.

7. The timepiece according to claim 1, wherein the first casing circle covers the horology movement and holds a dial on an upper face of the first casing circle.

8. The timepiece according to claim 7, wherein the dial is attached to the upper face of the first casing circle.

9. The timepiece according to claim 1, wherein the first casing circle covers the horology movement and in that an upper face of the first casing circle forms a dial.

10. A method for casing a movement of a timepiece in a middle according to claim 1, comprising the following successive steps:
a. a step in which the first casing circle and the horology movement are pre-assembled, such that an upper portion of the peripheral rib of the horology movement presses against an annular shoulder of the first casing circle;
b. a step in which the sub-assembly formed in the preceding step is inserted into the middle such that the first casing circle presses against a shoulder of the middle, the upper portion of
the peripheral rib of the horology movement pressing against an annular shoulder of the first casing circle;
c. a step in which the second casing circle is inserted into the middle, the second casing circle pressing against a lower portion of the peripheral rib of the horology movement, with no direct contact with the first casing circle;
d. a step in which the clamping element is clamped in the middle such that the stack formed by the second casing circle, the horology movement and the first casing circle is compressed against the shoulder of the middle.

11. The method for casing a movement of a timepiece in a middle according to claim 10, wherein the clamping step is carried out by screwing the clamping element into the middle.
